(19) United States
(12) Patent Application Publication
(10) Pub. No.: US 2023/0067937 A1
(43) Pub. Date: Mar. 2, 2023

(54) SYSTEM AND METHOD FOR MONITORING PEOPLE IN THE STORE

(71) Applicant: MariElectronics Oy, Vantaa (FI)

(72) Inventor: Göran SUNDHOLM, Tuusula (FI)

(73) Assignee: MariElectronics Oy, Vantaa (FI)

(21) Appl. No.: 17/410,827

(22) Filed: Aug. 24, 2021

(51) Int. Cl. G06Q 30/02; G06K 9/00

(52) U.S. Cl. CPC G06Q 30/0201; G06K 9/00335

(57) ABSTRACT

A system and method for monitoring persons in a store. The method includes monitoring movement of persons in the store with means for detecting movement, presence and/or location of a person, determining product purchase information and/or information related to picking a product from a shelf, the information received from POS-system, cash register, camera system, RFID reader, or a sensor, such as a shelf sensor, determining location of the sold and/or products taken from a shelf based on the determined product purchase information and a shelf-map of the store and/or the location information related to an electronic price label related to a product, and providing customer product selection event information for a specific product, for a specific product type, and/or specific location of the store based on determined location of sold products, information related to picking the product from the shelf and monitored movement of persons on a certain location of a store, e.g. in proximity of a certain shelf.

### FIELD OF THE INVENTION

The invention relates to a system and method for monitoring people in a store.

### BACKGROUND OF THE INVENTION

The price information of price labels in retail stores has conventionally been changed manually always when the price of a product changes. New prices are printed onto paper or onto a corresponding material and these labels, with their new price markings, are manually disposed in a location reserved for price labels on the shelves in sales premises. Thus, an employee must first find the correct location of the price label to be updated, after which the previous price label is taken out and discarded and the new price label is placed into its position. A drawback of this solution is inter alia that the solution is very laborious and very prone to error. When an error occurs, a situation can arise e.g. in which there is conflicting price information between the price information of the price labels on the shelves and the price information in the checkout system.

To avoid the aforementioned drawbacks, electronic systems have been developed that comprise electronic display units, with electronic displays, on the front edges of shelves or on the products, and the product price information on the displays of these units can be changed centrally from the control center of the system. This makes the updating of price information much easier and much faster. Depending on the system, the information on the displays can be updated by wireline or wirelessly. A problem in wireline systems is that a conductor connection for data transfer, and possibly also for power supply, must be arranged to each display. Since normal stores selling fast-moving consumer goods have a very large number of displays, there must also be a large number of conductors, which causes problems and places limitations on e.g. the placement of price displays.

Complex wirings are not needed in wireless systems, but correspondingly such systems need transmitter-receivers provided with antennas in connection with battery-powered or accumulator-powered price displays, by means of which transmitter-receivers they communicate with the control unit of the system via suitable communications means.

One method in endeavoring to minimize the electricity consumption of the display units, and thus to lengthen the operating time of their batteries/accumulators, is that in the communication between base stations and display units the transmitter-receiver disposed in the display units does not itself implement active radio transmission, whereby the transmission power would be produced on the basis of the display unit's own power source, but instead the display unit only reflects the radio transmission of the base station back at a certain time and in a certain way. A display unit can change the reflectance of its own antenna, in which case the display unit can acknowledge or respond to base station messages with simple response messages.

Modern radio-based wireless electronic price label systems are in power-saving mode for a large part of the time in order to minimize energy consumption. They switch from power-saving mode to listening mode/receiving mode at certain predefined intervals and only then can a message addressed to an electronic label be received by the electronic price label. That being the case, a problem in modern electronic price label systems is that messages and commands that are intended for an electronic price label do not reach the electronic price label immediately but instead at a predetermined time after the electronic price label has awoken from power-saving mode. If a certain base station does not reach a certain electronic price label in its operating range, searching for the label must be continued in the operating ranges of other base stations. The search, described above, for an electronic price label to be performed with a radio-frequency electronic price label system takes time, and transmissions to other price labels cannot necessarily be carried out during the search. This is a problem in particular in the case of electronic price labels to be fastened to products, because their location in the sales premises can often change.

Also other separate systems are presented in the prior art which can be used to monitor people in the store environment, but these separate prior art solutions are difficult to install and integrate to other system and they are also not able to provide reliable information on customer behavior.

### BRIEF DESCRIPTION OF THE INVENTION

The purpose of the solution according to the invention is to eliminate the problems of prior art. The method according to the invention is characterized by what is stated in the characterization part of claim 1. The method according to the invention is also characterized by what is stated in claims 2-10. The system according to the invention is characterized by what is stated in the characterization part of claim 11 relating to the system. The system according to the invention is also characterized by what is stated in the characterization part of claims 12-20 relating to the system.

According to a first aspect, the invention relates to a method for monitoring persons in a store. The method comprises monitoring movement of persons in the store with means for detecting movement, presence and/or location of a person, determining product purchase information and/or information related to picking a product from a shelf, the information received from POS-system, cash register, camera system, RFID reader, or a sensor, such as a shelf sensor, determining location of the sold and/or products taken from a shelf based on the determined product purchase information and a shelf-map of the store and/or the location information related to an electronic price label related to a product, and providing customer product selection event information for a specific product, for a specific product type, and/or specific location of the store based on determined location of sold products, information related to picking the product from the shelf and monitored movement of persons on a certain location of a store, e.g. in proximity of a certain shelf.

In one embodiment of the invention the customer product selection information comprises number of products sold in a certain time, e.g. during an hour and/or during a day, for a certain location at the store, e.g. for a certain shelf, and/or information relating to how a certain product has been sold in respect to the other products.

In one embodiment of the invention the monitoring movement of persons comprises monitoring locations where people move, where they are stationary and/or how long people are stationary at a certain location.

In one embodiment of the invention the method further comprises determining how long duration people are examining products before buy-decision, e.g. how long they spend time stationary beside certain product that has been determined to have been purchased.

In one embodiment of the invention the means for detecting movement, presence and/or location of a person comprises at least one sensor, such as a radar and or a camera, which is arranged to a ceiling or wall of the store, at the shelf, and/or at an electronic price label arranged to the store, e.g. arranged at the shelf.

In one embodiment of the invention the means for detecting movement, presence and/or location of a person further determines that a certain product is taken from the shelf and/or put back to shelf, and/or provides heat mapping data of a certain shelf.

In one embodiment of the invention monitoring movement of a person comprises determining a route used by a person in the store with means for detecting movement, presence and/or location of a person.

In one embodiment of the invention the means for detecting movement, presence and/or location of a person further determines fill ratio of at least one shelf or part of a shelf.

In one embodiment of the invention the method comprises sending a message to a mobile device of a person at a certain location based on the determination of the presence of the person at the location.

In one embodiment of the invention the shelf map is static, and e.g. updated manually when products are relocated in the store, or shelf map of the store is dynamic, and e.g. automatically updated when an electronic price label is relocated in a store, wherein the systems senses or determines electronic price label's location in the store and/or the electronic price label senses or determines its location in the store.

According to a second aspect, the invention relates to a system for monitoring persons in a store. The system comprises means for detecting movement, presence and/or location of a person and means to determining product purchase information and/or information related to picking a product from a shelf, such as a POS-system, cash register, camera system, RFID reader and/or a sensor, e.g. a shelf sensor. The system is configured to monitor movement of persons in the store with means for detecting movement, presence and/or location of a person, to determine product purchase information and/or information related to picking a product from a shelf, the information received from the POS-system, the cash register, the camera system, the RFID reader and/or or the sensor, e.g. a shelf sensor, to determining location of the sold and/or products taken from a shelf based on the determined product purchase information and a shelf-map of the store and/or the location information related to an electronic price label related to a product, and to provide customer product selection event information for a specific product, for a specific product type, and/or specific location of the store based on determined location of sold products, information related to picking the product from the shelf and monitored movement of persons on a certain location of a store, e.g. in proximity of a certain shelf.

In one embodiment of the invention the system is configured to determine customer product selection information which comprises number of products sold in a certain time, e.g. during an hour and/or during a day, for a certain location at the store, e.g. for a certain shelf, and/or information relating to how a certain product has been sold in respect to the other products.

In one embodiment of the invention the system is configured to monitor movement of persons by monitoring locations where people move, where they are stationary and/or how long people are stationary at a certain location.

In one embodiment of the invention the system is further configured to determine how long duration people are examining products before buy-decision, e.g. how long they spend time stationary beside certain product that has been determined to have been purchased.

In one embodiment of the invention the means for detecting movement, presence and/or location of a person comprises at least one sensor, such as a radar and or a camera, which is arranged to a ceiling or wall of the store, at the shelf, and/or at an electronic price label arranged to the store, e.g. arranged at the shelf.

In one embodiment of the invention the means for detecting movement, presence and/or location of a person is further configured to determine that a certain product is taken from the shelf and/or put back to shelf, and/or to provide heat mapping data of a certain shelf.

In one embodiment of the invention the system is configured to monitor movement of a person at least by determining a route used by a person in the store with means for detecting movement, presence and/or location of a person.

In one embodiment of the invention the means for detecting movement, presence and/or location of a person are further configured to determine fill ratio of at least one shelf or part of a shelf.

In one embodiment of the invention the system is further configured to send a message to a mobile device of a person at a certain location based on the determination of the presence of the person at the location.

In one embodiment of the invention the shelf map is static, and e.g. updated manually when products are relocated in the store, or shelf map of the store is dynamic, and e.g. automatically updated when an electronic price label is relocated in a store, wherein the systems is configured to sense or determine electronic price labels location in the store and/or the electronic price label is configured to sense or determine its location in the store.

With the solution of the invention, it's possible to obtain valuable information for purchased products, their location, how long people have examined the products, etc. This information can be utilized e.g. in the management and/or in the store. Also in the solution of the invention information and data collected from multiple systems is used to provide higher quality data and more reliable customer behavior data than with the prior art systems.

Various other advantages will become clear to a skilled person based on the following detailed description.

The expression “a plurality of” refers herein to any positive integer starting from two, e.g. to two, three, or four. The terms “first”, “second” and “third” do not denote any order, quantity, or importance, but rather are used to distinguish one element from another.

The exemplary embodiments of the present invention presented herein are not to be interpreted to pose limitations to the applicability of the appended claims. The verb “to comprise” is used herein as an open limitation that does not exclude the existence of also un-recited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF THE FIGURES

In the following, the invention will be described in more detail by the aid some embodiments with reference to the drawings 1-5, wherein

FIG. 1 presents a diagrammatic and simplified electronic price label system according to one embodiment of the invention,

FIG. 2 presents in a simplified manner a base station of an electronic price label system according to one embodiment of the invention, and

FIG. 3 presents in a simplified manner one example embodiment related to arranging means for detecting movement, presence and/or location of a person in a store,

FIG. 4 presents in a simplified manner one example embodiment related to arranging means for detecting movement, presence and/or location of a person in a store viewed from above,

FIG. 5 presents in a simplified manner one example embodiment related to arranging at least part of the solution of the invention to a store.

### DETAILED DESCRIPTION OF THE INVENTION

In the solution of the invention information from different sources and sensors is collected, e.g. product location information obtained by locating an electronic price labels, motion detection data from person moving in the store, e.g. collected with radar-based sensor and/or cameras, and purchase information generated e.g. at the checkout. The information from multiple sources is used to provide purchase decision related information of the customers of the store, such as how long customers research different products before making a purchase decision whether they compare similar products and end up with something specific. Also, other customer sales related information and e.g. visualization relating to the purchase decision can be provided with the solution of the invention.

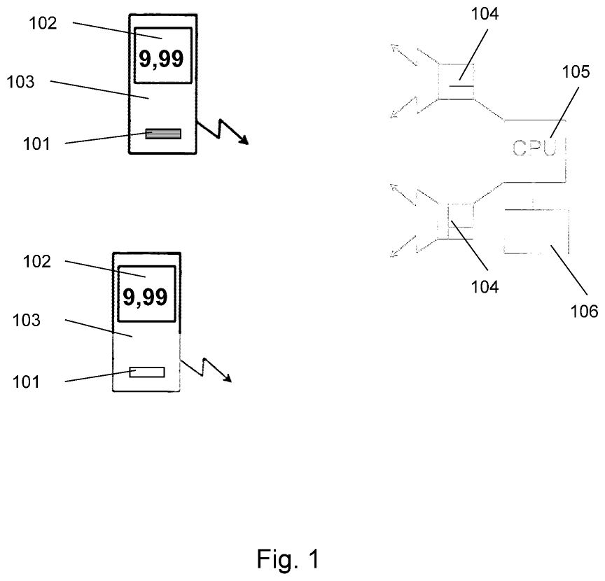

FIG. 1 presents in a diagrammatic and simplified manner an electronic label system which can be used with the solution of the invention. In this example embodiment electronic price labels 103 can be affixed to products and/or to shelves. The display 102 of the electronic price labels is arranged to show information relating to a product, such as e.g. price, product name and possibly some other information relating to the product. Electronic price labels can communicate with the rest of the system via base stations 104.

According to one embodiment of the invention, the electronic price label system can comprise, in addition to electronic price labels, at least communication means 106, such as a central unit 105 provided with a radio transmitter, via which e.g. updated price information and other control data can be sent via the base stations 104 of the system to the electronic price labels 103. In addition, it has been possible to connect to the system scanners that are at the checkout registers, said scanners scanning the price of a product and being connected to the checkout system, in which case the checkout system and the electronic price labels always have the same up-to-date information about the prices of products. The central unit 105 can be further connected to other controlling systems or supporting systems. The wireless connection between the base stations 104 and the electronic price labels 103 is described with arrows.

The electronic price label to be used in the system according to one embodiment of the invention comprises communication means, by the aid of which the electronic price label can communicate with a radio-frequency electronic price label system. In the embodiment in question, the electronic price label also comprises an identifier, e.g. an RFID identifier, to be used in locating the position of a label. In the communication to be used with labels, the electronic price label system makes good use of both an identifier to be used in locating a position, such as RFID, and radio-frequency communication, in which an electronic price label reflects back a transmission it receives. The electronic price label system can thereby e.g. locate the position of the identifier of a certain electronic price label, e.g. by means of RFID, and when the location of the price label in question is clear, the system can send information to the electronic price label with the base station operating in the area in question via bidirectional radio-frequency communication, said information being e.g. price information or commands. The position localization can be performed e.g. in such a way that first a query is sent with the means for locating the position of a price label, e.g. via RFID, to an electronic price label. When the electronic price label responds to the query, the system quickly ascertains in which operating range of which base station of the electronic price label system the electronic price label is located. After this the electronic price label system can send with the base station in question new price information and/or a command to the electronic price label using a radio-frequency communication method, in which the electronic price label can respond to the message by reflecting back the message it receives.

An advantage of the arrangement described above is that, by means of the identifier of an electronic price label, the electronic price label can be positioned more rapidly than in the case of a radio-frequency electronic price label system in which an electronic price label responds to a base station by reflecting back a message it receives. When it is known in which operating range of which base station of the electronic price label system an electronic price label is located, it is more advantageous to communicate via a radio-frequency electronic price label system than e.g. via an RFID system, because this uses less energy in the electronic price label. In one embodiment of the invention RFID is only used to detect under which base station (and its coverage area) the electronic price label is located.

In one embodiment the direction of identifier of the electronic price label can be detected by a base station and when multiple base stations are used to measure the identifier of the electronic price label, the location of the electronic price label can be precisely identified by using the measurement results of multiple base stations, e.g. the measurement results of a single base station relating to determined direction of the electronic price label from that specific base station.

In one embodiment of the invention, position localization is performed only when an electronic price label does not respond from its previous location or the previous location is not known to the system, such as can be the situation e.g. in the case of bringing new products and the price labels attached to them into the sales premises.

In one embodiment of the invention, the electronic price label system can also form a list of possible base stations specific to a price label, within the operating range of which base station the price label can be found. The different base stations in the list can be arranged in sequence, e.g. on the basis of the probability of a certain electronic price label being found within the operating range of each base station. If a label is contacted within the range of a certain base station, the priority of the base station in question can be raised in the sequential list of base stations of a certain price label. If a label cannot be contacted within the range of a certain base station, the priority of the base station in question can be lowered in the sequential list of base stations of the particular price label. Also the result of position localization performed with RFID or with other means can be used in arranging the sequence of the base station list of a certain price label according to which base station range the electronic price label will probably be found in. In such a case, the priority of the base station of the electronic price label system, within the range of which base station the electronic price label is found by the aid of the means for locating the position of price labels, can be raised in the base station list. By means of this type of arrangement, an electronic price label system is able to adapt to a changing environment and to keep transmissions made in the ranges of the incorrect (from the viewpoint of a certain price label) base stations to as few as possible. The product group of a product associated with a certain price label can also be used as a sequencing criterion in the list of base stations, the occurrence of which product group in the range of a particular base station can be more probable than in the range of another base station. The lifecycle phase of the product or price label associated with the price label in question can also be used as a sequencing criterion. In one embodiment of the invention, a base station having an operating range within which the electronic price label is most probably located is used in the transmission, i.e. a base station that is first on the base station list of a certain price label.

In the following one example of what e.g. an electronic price label affixable to a product can be like is presented in more detail. A receiver provided with a display controller connected to a display and with an antenna is affixed to an electronic price label, and so also is a power source that is e.g. an ordinary battery. The power source is arranged to provide electrical energy to the electronic price label and to its display controller. The price information or other information visible on the display can be updated wirelessly from the central unit via the receiver and display controller. In this embodiment, the update information and control information are transferred by means of radio waves, but other data transfer modes are possible.

Each electronic price label forms a thin price label, provided with a display, similar in appearance to a paper price label, on which the necessary prices of products, together with other needed markings, are formed by changing the color of the display segments. The color of the display segments and also of the background is changed by means of an electrical field formed by an electric current, as is described above.

The display of an electronic price label to be used in the system according to the invention can be implemented e.g. as an electronic laminated display, which forms a thin price label provided with display segments and similar in appearance to a paper price label, on which the information relating to a product, e.g. the prices of products together with other needed markings, are presented by changing the color of the display segments. One layer of the display is e.g. an active ink layer. In the ink layer are numerous microcapsules filled with liquid, which microcapsules contain e.g. essentially black particles that are positively surface-charged and essentially white particles that are negatively surface-charged, the placement of which particles in the microcapsules is controlled with an electrical field such that for the desired display segments the black particles are at the top, in which case those display segments appear to be black when viewed from above, and for the other display segments the white particles are at the top, in which case these display segments appear to be pale when viewed from above. The background of the display consists of the same microcapsules, so that e.g. price information can be presented as dark numbers against a light background or, if desired, vice versa. For example, the electrophoretic microcapsule laminated display presented in Finnish patent application no. FI 20050192 can be used as this type of display.

In the following, the communication of an electronic price label with a base station by means of a reflection between the unit in question and the system wirelessly controlling it will be described in slightly more detail and in an exemplary manner in the case of one embodiment of the invention.

In this communication example the base stations can communicate with the display units by sending signals that all the display units listen to and from which signals an individual display unit identifies a command addressed specifically to it on the basis of the identifier specific to that display unit. After receiving a command addressed to itself, an individual display unit can respond to the base station by reflecting the base station's own transmission back to the base station modified by the amount of the phase shift caused by a certain time delay and at a certain moment in time. Typically, after sending a command intended for a certain price display, a base station starts to send for a certain time e.g. a certain type of carrier wave, which the price display that identified the command reflects back with a certain phase shift. A base station is thus able to identify a reflection response as belonging to a certain price display because it is able to wait for a certain period of time after the individualized command it sends to the display in question. The base station can distinguish from its own transmission the reflection response of considerably weaker power than the transmission, based on the phase shift produced in it by the display device.

In the example arrangement, the electronic price label has state-changing means for changing the state of the antenna of the receiver between at least two states, in which e.g. in the first state the reflectivity of the antenna is good and in the second state the reflectivity is poor. Correspondingly, the antenna states can be adapted with the state-changing means in such a way that in different states the antenna reflects radio waves in different phases. In this case, therefore, the electronic price label is adapted to change the state of the antenna of its receiver in order to produce a coded reflection in a certain manner with a different time delay according to the state of the antenna. The communication means connected to a base station interpret different time delays as coded data signals sent by an electronic price label, and e.g. the communication means identify each electronic price label based on these data signals.

The aforementioned coding at its simplest is that an electronic price label reflects back the carrier wave transmitted by the communication means, which carrier wave can have a frequency of e.g. 685 MHz, in such a way that the electronic price label earths the receiver antenna by means of the state-changing means e.g. at a frequency of 150 kHz, thus forming a certain type of square wave from the reflected signal. The electronic price label thus affects the reflected signal by changing the state of the antenna. In this reflection, the phase shift undergone by the signal would most suitably be 180 degrees, at which detection of a low-power reflection with the communication means is at its best. Electronic price labels are in power-saving mode for much of the time and at times change their state to receiving mode. In receiving mode, they can detect message, e.g. new price information, sent to them and execute commands given to them.

After sending a command, the central unit of the apparatus can send information about the changes in the state of the electronic price label that occurred and/or were executed onwards via the network, e.g. to a POS system. The apparatus can also receive information intended to be sent to a certain electronic price label via a network, e.g. from a POS system. This type of information can be e.g. price information to be shown on the display of the electronic price label or extinguishing information.

Use of the invention is not limited to price displays using the type of display technology of the type described above, but instead it is obvious that the price displays can be implemented using any technology whatsoever that is known in the art. The solution described above relates specifically to how the communication of the electronic price labels and the electronic price label system can be efficiently arranged.

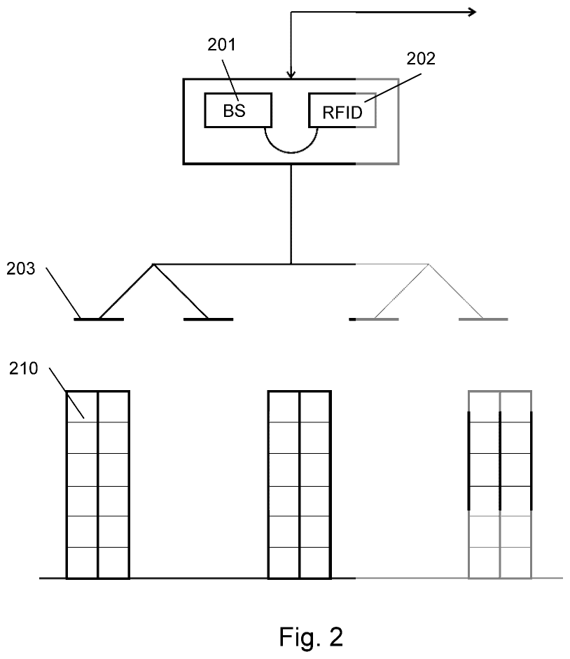

FIG. 2 presents in a simplified manner the base stations of an electronic price label system according to some embodiments of the invention. According to these embodiments, a base station comprises communication means for bidirectional radio-frequency communication with the electronic price labels that are e.g. fastened to products on the shelves 210. A base stations is adapted to communicate with the electronic price labels in such a way that the electronic price labels reflect back a transmission they receive from a base station. The system also comprises means for locating the position of the identifiers to be used in locating position, said identifiers being in the electronic price labels, e.g. means for reading RFID tags. In the embodiment of FIG. 2 the base station of the electronic price label system and the means for locating the position of price labels use the same antennas. In this way it can also be reliably deduced by means of position localization in which operating area of which base station the located electronic price label is situated. The system can e.g. alternate traffic of the means for locating the position of electronic price labels and of the base stations of the electronic price labels and/or distribute operating time to different units according to need.

In one embodiment of the invention, the RFID system and the radio-frequency electronic price label system can operate in essentially the same frequency range, in which case the same antenna of the base station of the electronic price label system can be used in both communication occurring via RFID and in communication occurring with the radio-frequency electronic price label system. In such a case, a base station of the electronic price label system can comprise a switch that is adapted to connect one and the same antenna to the RFID communication means and to the communication means of the radio-frequency electronic price label system alternately and/or according to need.

In the embodiment of FIG. 2 the means for locating the position of a price label are arranged in connection with the base stations. In the case of the embodiment in question, the means for locating the position of price labels is an RFID reader 202 that is connected to a base station 201 of the electronic price label system via wired or wireless means, such as e.g. via a USB interface. The RFID reader 202 and base station 202 can be situated in a common unit although functionally they are separate units. In the embodiment of FIG. 2 the RFID reader 202 and the base station 201 use the same antennas 203.

In one embodiment of the invention the means for locating the position of electronic price labels are integrated into a base station 201 of the electronic price label system. In one embodiment the means for locating the position of electronic price labels and the base station can use the same antennas 203. The means for locating the position of electronic price labels can be an RFID reader.

The means for locating the position of price labels can thus be arranged apart from the base stations of the electronic price label system and/or they can use their own and separate antennas.

In one embodiment of the invention, the electronic price label system can further comprise security gates, and an alarm signal can be based on a response of the security gates when an electronic price label is taken though a security gate.

In one embodiment of the invention, the electronic price label system can further comprise RFID readers that can be arranged e.g. in connection with exits, e.g. above them. In this embodiment, an alarm signal can be based on a response of an RFID reader when an electronic price label comprising an RFID identifier is taken into the reading range of the RFID reader.

With the means to detecting movement, presence and/or location of a person used in the solution of the invention the system is able to collect relating to customer product selection event information for example for a specific product, product group and/or product type, e.g. which part of the shelf people go and which shelf and which part of the shelf they stop, specific location of the store based on determined location of sold products, information related to picking the product from the shelf and monitored movement of persons on a certain location of a store, e.g. in proximity of a certain shelf.

In one embodiment of the invention the means for detecting movement used in the solution of the invention comprise at least one sensor, such as a radar and or a camera, which is arranged to a ceiling or wall of the store, at the shelf, and/or at an electronic price label arranged to the store, e.g. arranged at the shelf.

In one embodiment of the invention RFID of a product or an electronic price label attached to the product can be used to track the movement of the product in a store. This way it is also possible to track movement of the customers as they are moving with the product which they have taken with them. This way further customer selection information can be gathered from the store environment.

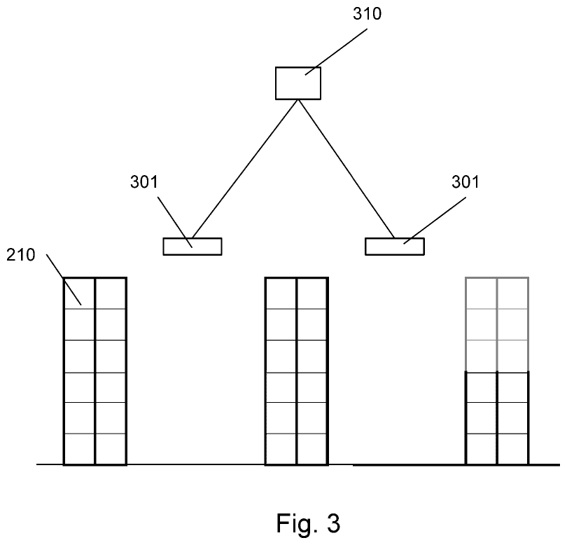

FIG. 3 presents how the means for detecting movement, presence and/or location of a person 301 can be arranged in a store in one example embodiment. In this example embodiment the means for detecting the movement 301 are arranged above the aisles between the shelves of the store so that means to detecting movement, presence and/or location of a person are able to measure an area between the shelves where people are moving. The sensors can be arranged so that they are directed directly downwards or slightly tilted. The means to detecting movement, presence and/or location of a person can comprise multiple sensors and they can be connected to a control unit 310 which controls operation of the means to detecting movement, presence and/or location of a person 301.

In one embodiment of the invention monitoring of movement of persons comprises monitoring locations where people move, where they are stationary and/or how long people are stationary at a certain location. It can be determined how long duration people are examining products before buy-decision, e.g. how long they spend time stationary beside certain product that has been determined to have been purchased.

In one embodiment of the invention the customer product selection information which is determined in the solution of the invention can comprise number of products sold in a certain time, e.g. during an hour and/or during a day, for a certain location at the store, e.g. for a certain shelf, and/or information relating to how a certain product has been sold in respect to the other products.

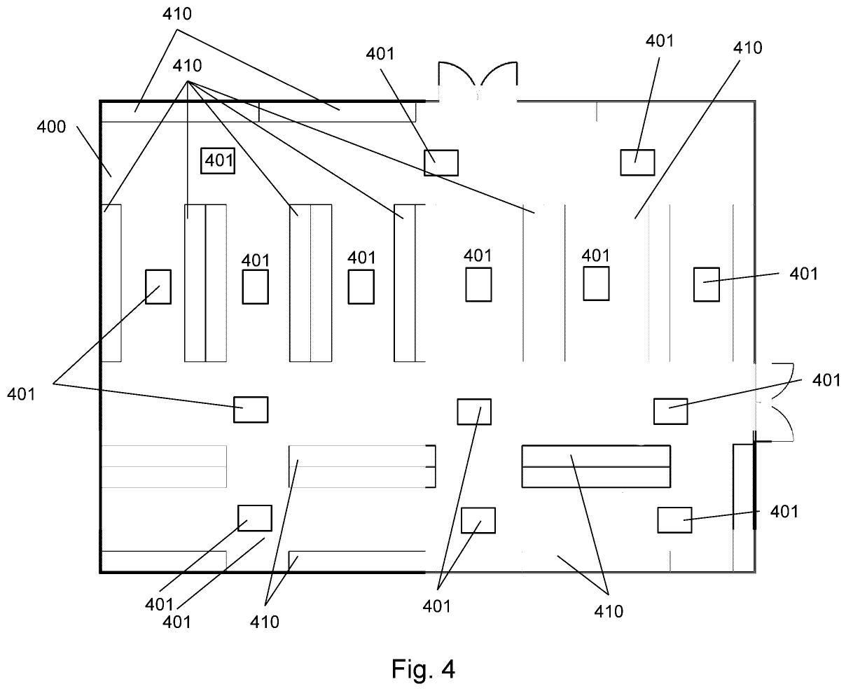

FIG. 4 presents in a simplified manner one example embodiment related to arranging means for detecting movement, presence and/or location of a person in a store viewed from above. Also, in this example the means for detecting the movement 401 are arranged above the aisles between the shelves 410 of the store so that means to detecting movement, presence and/or location of a person are able to measure an area between the shelves where people are moving. In this example the measurement area of all the means for detecting movement, presence and/or location of a person 401 arranged in the store covers essentially all areas 400 where people can be moving.

In one embodiment of the invention the system comprises a shelf map of the store. The shelf map can be static, and e.g. updated manually when products are relocated in the store, or shelf map of the store can be dynamic, and e.g. automatically updated when an electronic price label is relocated in a store, wherein the systems senses or determines electronic price label's location in the store and/or the electronic price label senses or determines its location in the store. With this kind of dynamic shelf map the height position of the product at the shelf can't be always automatically determined. Further sensors, such as planar sensors arranged on the shelfs or camera-based sensors directed to shelfs may be added to the system to detect or define also the height of the product in the shelf.

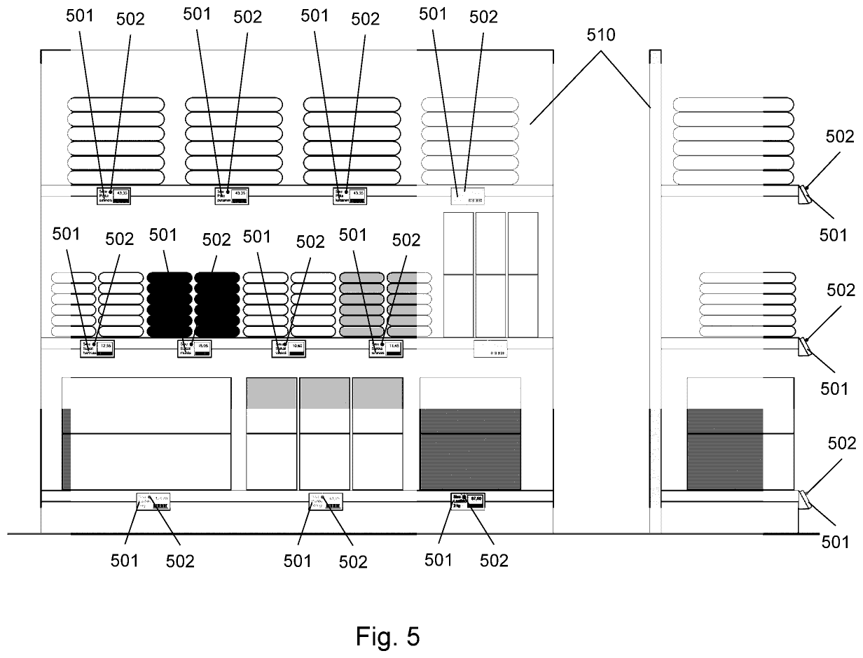

FIG. 5 presents in a simplified manner one example embodiment related to arranging at least part of the solution of the invention to a store. In this example electronic price labels are arranged to the sides of the shelves 510. The electronic price labels 501 comprise a camera-based sensor 502 which can be used to determine product purchase information and/or information related to a person picking a product from a shelf. The camera-based sensor can be arranged to essentially every electronic price label 501 or only to some electronic price labels, e.g. so that the area from which the camera is able to monitor persons, cover essentially all products in the area. In one example embodiment camera-based sensors can be arranged separately from the electronic price labels as separate units which can be arranged e.g. to a side of the shelf, wall or ceiling.

With the sensors used in the solution of the invention a “heat map” type of image at different times can be provided from which it can be seen how many customers have been moving in a certain time in certain areas and corridors. This information can be used for example for targeted marketing and pricing. In one embodiment of the invention the means for detecting movement, presence and/or location of a person are used to determine that a certain product is taken from the shelf and/or put back to shelf, and/or this way heat mapping data of a certain shelf can be firmed and/or provided.

In one embodiment of the invention the means for detecting movement, presence and/or location of a person can determine fill ratio of at least one shelf or part of a shelf and in another embodiment fill ration can be determined with an additional sensor, e.g. a planar sensor arranged to the shelf or a sensor, such as a camera or distance measuring sensor, arranged for example to the opposite side of the aisle.

In the solution of the invention POS system can provide information on which products have been purchased, at what time and from the electronic price label system or shelf map where each product is placed in the store. Combining this information and using time constraints (delay in taking the product off the shelf until it is at the checkout) will make it possible to form an estimate of the purchase information related to certain products.

In one embodiment of the invention the method comprises sending a message to a mobile device of a person at a certain location based on the determination of the presence of the person at the location.

In one embodiment of the invention the system, e.g. an electronic price label system can comprise a routing programs based on a shopping list and store map. The route determined based on the means to detect movement, presence and/or location of a person can be used to compare which products cause the customers to deviate from the planned route and planned products of the shopping list. This information can be used in targeted marketing and pricing, e.g. at the store. In one embodiment of the invention monitoring movement of a person comprises determining a route used by a person in the store with means for detecting movement, presence and/or location of a person.

In a case where the store comprises a sensor network comprising multiple sensors customer movement can be monitored from one sensor to another and/or the route traveled by an individual customer can be stored and compared. The motion observations generated by certain type of sensor, e.g. the radar-based sensor, can be supplemented with other motion tracking systems such as cameras, PIR sensors, etc.

The embodiments of the invention described herein before in association with the figures presented and the summary of the invention may be used in any combination with each other. At least two of the embodiments may be combined together to form a further embodiment of the invention.

The specific examples provided in the description given above should not be construed as limiting the applicability and/or the interpretation of the appended claims. Lists and groups of examples provided in the description given above are not exhaustive unless otherwise explicitly stated.

1. A method for monitoring persons in a store, the method comprising:
monitoring movement of persons in the store with means for detecting movement, presence and/or location of a person,
determining product purchase information and/or information related to picking a product from a shelf, the information received from POS-system, cash register, camera system, RFID reader, or a sensor, such as a shelf sensor,
determining location of the sold and/or products taken from a shelf based on the determined product purchase information and a shelf-map of the store and/or the location information related to an electronic price label related to a product, and
providing customer product selection event information for a specific product, for a specific product type, and/or specific location of the store based on determined location of sold products, information related to picking the product from the shelf and monitored movement of persons on a certain location of a store, e.g. in proximity of a certain shelf.

2. A method according to claim 1, wherein the customer product selection information comprises number of products sold in a certain time, e.g. during an hour and/or during a day, for a certain location at the store, e.g. for a certain shelf, and/or information relating to how a certain product has been sold in respect to the other products.

3. A method according to claim 1, wherein the monitoring movement of persons comprises monitoring locations where people move, where they are stationary and/or how long people are stationary at a certain location.

4. A method according to claim 1, wherein the method further comprises determining how long duration people are examining products before buy-decision, e.g. how long they spend time stationary beside certain product that has been determined to have been purchased.

5. A method according to claim 1, wherein the means for movement, presence and/or location of a person comprises at least one sensor, such as a radar and or a camera, which is arranged to a ceiling or wall of the store, at the shelf, and/or at an electronic price label arranged to the store, e.g. arranged at the shelf.

6. A method according to claim 1, wherein the means for detecting movement, presence and/or location of a person further determines that a certain product is taken from the shelf and/or put back to shelf, and/or provides heat mapping data of a certain shelf.

7. A method according to claim 1, wherein monitoring movement of a person comprises determining a route used by a person in the store with means for detecting movement, presence and/or location of a person.

8. A method according to claim 1, wherein the means for detecting movement, presence and/or location of a person further determines fill ratio of at least one shelf or part of a shelf.

9. A method according to claim 1, wherein the method comprises sending a message to a mobile device of a person at a certain location based on the determination of the presence of the person at the location.

10. A method according to claim 1, wherein the shelf map is static, and e.g. updated manually when products are relocated in the store, or shelf map of the store is dynamic, and e.g. automatically updated when an electronic price label is relocated in a store, wherein the systems senses or determines electronic price label's location in the store and/or the electronic price label senses or determines its location in the store.

11. A system for monitoring persons in a store, the system comprising means for detecting movement, presence and/or location of a person and means to determining product purchase information and/or information related to picking a product from a shelf, such as a POS-system, cash register, camera system, RFID reader and/or a sensor, e.g. a shelf sensor, wherein the system is configured
to monitor movement of persons in the store with means for detecting movement, presence and/or location of a person,
to determine product purchase information and/or information related to picking a product from a shelf, the information received from the POS-system, the cash register, the camera system, the RFID reader and/or or the sensor, e.g. a shelf sensor,
to determining location of the sold and/or products taken from a shelf based on the determined product purchase information and a shelf-map of the store and/or the location information related to an electronic price label related to a product, and
to provide customer product selection event information for a specific product, for a specific product type, and/or specific location of the store based on determined location of sold products, information related to picking the product from the shelf and monitored movement of persons on a certain location of a store, e.g. in proximity of a certain shelf.

12. A system according to claim 11, wherein the system is configured to determine customer product selection information which comprises number of products sold in a certain time, e.g. during an hour and/or during a day, for a certain location at the store, e.g. for a certain shelf, and/or information relating to how a certain product has been sold in respect to the other products.

13. A system according to claim 11, wherein the system is configured to monitor movement of persons by monitoring locations where people move, where they are stationary and/or how long people are stationary at a certain location.

14. A system according to claim 11, wherein the system is further configured to determine how long duration people are examining products before buy-decision, e.g. how long they spend time stationary beside certain product that has been determined to have been purchased.

15. A system according to claim 11, wherein the means for detecting movement, presence and/or location of a person comprises at least one sensor, such as a radar and or a camera, which is arranged to a ceiling or wall of the store, at the shelf, and/or at an electronic price label arranged to the store, e.g. arranged at the shelf.

16. A system according to claim 11, wherein the means for detecting movement, presence and/or location of a person is further configured to determine that a certain product is taken from the shelf and/or put back to shelf, and/or to provide heat mapping data of a certain shelf.

17. A system according to claim 11, wherein the system is configured to monitor movement of a person at least by determining a route used by a person in the store with means for detecting movement, presence and/or location of a person.

18. A system according to claim 11, wherein the means for detecting movement, presence and/or location of a person are further configured to determine fill ratio of at least one shelf or part of a shelf.

19. A system according to claim 11, wherein the system is further configured to send a message to a mobile device of a person at a certain location based on the determination of the presence of the person at the location.

20. A system according to claim 11, wherein the shelf map is static, and e.g. updated manually when products are relocated in the store, or shelf map of the store is dynamic, and e.g. automatically updated when an electronic price label is relocated in a store, wherein the systems is configured to sense or determine electronic price labels location in the store and/or the electronic price label is configured to sense or determine its location in the store.
